(19) United States
(12) Patent Application Publication
(10) Pub. No.: US 2012/0055964 A1
(43) Pub. Date: Mar. 8, 2012

(54) CONTAINER WITH REMOVABLE WRIST BAND AND METHOD OF MAKING AND USING THE SAME

(75) Inventor: Robert J. GLUCK, Lawrence, NY (US)

(73) Assignee: ROBERT GORDON INDUSTRIES, LTD., New Hyde Park, NY (US)

(21) Appl. No.: 12/875,572

(22) Filed: Sep. 3, 2010

(51) Int. Cl. A45F 5/00; B23P 11/00

(52) U.S. Cl. 224/267; 29/428

(57) ABSTRACT

A container includes a container body, at least one groove or recess arranged on the container body, and a removable wrist band at least partially disposed in the at least one groove or recess. The wrist band is removable from the at least one groove or recess and wearable on a user's wrist. This Abstract is not intended to define the invention disclosed in the specification, nor intended to limit the scope of the invention in any way.

### BACKGROUND OF THE INVENTION

1. Field of the Invention

The invention relates to a container having a removable wrist band as well as a method of making and using the same.

2. Discussion of Background Information

Containers utilizing a removable wrist bracelets are known. For example, a sleeve on a coffee cup is known which provides the user with a better way to grip the cup. The sleeve can be worn as a bracelet. See Coffee Cup Cozy/Bracelet on the website www.reusablebags.com. Further, U.S. D381,046 to HIERS et al. and US 2008/0000992 to MEDIARE disclose a baby bottle surrounded by a bracelet with indicia. Cause or awareness bracelets or bands are also known.

### SUMMARY OF THE INVENTION

Conventional containers, however, do not utilize the unique combination of features of the instant invention. In particular, they do not utilize, among other things, a groove or recess and a removable wrist band (such as, e.g., a cause or awareness bracelet) which can be seated at least partially within the groove or recess.

The invention relates to a container having a groove or recess which is sized and configured to at least partially receive therein a removable wrist band. The invention also relates to a container having a groove or recess which is both sized and configured to at least partially receive therein a removable and expandable wrist band and which has text and/or indicia and/or one or more symbols arranged in the groove or recess. The invention also relates to a container having a removable wrist band and/or a groove or recess as well as text and/or indicia and/or one or more symbols arranged on an outer surface of the container. The invention also relates to a container having a removable wrist band and/or a groove or recess as well as text and/or indicia and/or one or more symbols arranged on at least one of: an outer surface of the container, an outer surface of the wrist band, and an outer surface of a wall forming a bottom of the groove or recess. The text, indicia, or symbols of these locations may be related and/or may be different from one another. The invention also relates to a method of making and using the container.

According to at least one non limiting embodiment of the invention, there is provided a container having a groove or recess which is both sized and configured to at least partially receive therein a removable and expandable wrist band and which has text and/or indicia and/or one or more symbols arranged in the groove or recess.

The invention, in embodiments, also relates to a container having a removable wrist band and/or a groove or recess as well as text and/or indicia and/or one or more symbols arranged on an outer surface of the container. In embodiments, the invention also relates to a container having a removable wrist band and/or a groove or recess as well as text and/or indicia and/or one or more symbols arranged on at least one of: an outer surface of the container, an outer surface of the wrist band, and an outer surface of a wall forming a bottom of the groove or recess. The text, indicia, or symbols of these locations may be related and/or may be different from one another.

According to at least one other non-limiting embodiment of the invention, there is provided a method of making and using the container described herein.

According to at least one other non-limiting embodiment of the invention, there is provided a container comprising a container body, at least one groove or recess arranged on the container body, and a removable wrist band at least partially disposed in the at least one groove or recess. The wrist band is removable from the at least one groove or recess and wearable on a user's wrist.

The wrist band may be at least one of: a one-piece member, a cause or awareness bracelet or band, an axial width of between about ¼ inch and about ½ inch, substantially disposed within the at least one groove or recess, and nearly fully disposed within the at least one groove or recess.

The wrist band may be elastically expandable and generally circular and/or generally cylindrically shaped. The wrist band may comprise text and/or indicia and/or one or more symbols. The container body may comprise text and/or indicia and/or one or more symbols. The at least one groove or recess may comprise text and/or indicia and/or one or more symbols.

The wrist band may comprise text and/or indicia and/or one or more symbols and the container body may comprise text and/or indicia and/or one or more symbols in any combination. The wrist band may comprise text and/or indicia and/or one or more symbols and the at least one groove or recess may comprise text and/or indicia and/or one or more symbols.

The wrist band may comprise text and/or indicia and/or one or more symbols, the container body may comprise text and/or indicia and/or one or more symbols, and the at least one groove or recess may comprise text and/or indicia and/or one or more symbols in any combination.

The wrist band may comprises text and/or indicia and/or one or more symbols and the container body may comprise different text and/or indicia and/or one or more symbols in any combination.

The wrist band may comprise text and/or indicia and/or one or more symbols and the at least one groove or recess may comprise different text and/or indicia and/or one or more symbols in any combination.

The wrist band may comprise text and/or indicia and/or one or more symbols, the container body may comprise different text and/or indicia and/or one or more symbols, and the at least one groove or recess may comprises different text and/or indicia and/or one or more symbols in any combination.

The container body may comprises at least one of; an inner wall and an outer wall and an inner wall and an outer wall and wherein the least one groove or recess is arranged on the outer wall.

The least one groove or recess may be at least one of arranged on a one-piece member and integrally formed with a wall of the container body.

The container body may comprise an outer wall having text and/or indicia and/or one or more symbols. The outer wall may be at least one of at least partially substantially transparent and at least partially substantially translucent.

The container body may comprises one of: an outer wall comprising a synthetic resin and an inner wall comprising a metal, an outer wall comprising a synthetic resin and an inner wall comprising a synthetic resin, an outer wall comprising a synthetic resin and an inner wall comprising stainless steel, and an outer wall comprising PVC and an inner wall comprising 18-8 stainless steel.

The container may further comprise at least one of a cap arranged to cover an opening of the container and at least one handle for gripping the container body.

The wrist band may be at least one of elastically expandable and comprises in at least two spaced apart locations text, indicia and/or at least one symbol and elastically expandable and comprises plural spaced apart locations a same text, indicia and/or at least one symbol.

The at least one groove or recess may comprise at least one of: plural spaced apart locations text, indicia and/or at least one symbol, plural spaced apart locations a same text, indicia and/or at least one symbol, and plural spaced apart locations of a trademark.

The invention also provides for a method of making the container of the type(s) described above, wherein the method comprises placing the removable wrist band in the at least one groove or recess.

The invention also provides for a method of using the container of the type(s) described above, wherein the method comprises removing the removable wrist band from the at least one groove or recess.

According to at least one other non-limiting embodiment of the invention, there is provided a container comprising a container body, at least one groove or recess arranged on the container body and having an axial width of between about ⅜ inch and about ½ inch, and a wrist band at least partially disposed in the at least one groove or recess. The wrist band is removable from the at least one groove or recess and wearable on a user's wrist. At least one of the wrist band comprises text and/or indicia and/or one or more symbols, the container body comprises text and/or indicia and/or one or more symbols, and the at least one groove or recess comprises text and/or indicia and/or one or more symbols.

According to at least one other non-limiting embodiment of the invention, there is provided a container comprising a container body, at least one circumferential groove or recess arranged on an outer surface of the container body, and a one-piece elastically expandable generally circular wrist band at least partially disposed in the at least one groove or recess. The wrist band is removable from the at least one groove or recess and wearable on a user's wrist. At least two of: the wrist band comprises text and/or indicia and/or one or more symbols, the container body comprises text and/or indicia and/or one or more symbols, and the at least one groove or recess comprises text and/or indicia and/or one or more symbols.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a side view of a container having a removable wrist band in accordance with at least one aspect of the invention. An optional cap is shown in dashed-lines;

FIG. 2 shows the container of FIG. 1 with the removable wrist band removed to expose the groove or recess which receives the wrist band;

FIG. 3 shows a side view of the removable wrist band used in the container of FIG. 1 after it has assumed a relaxed or non-expanded state;

FIGS. 4 and 5 show top and side enlarged views of the removable wrist band used in the container of FIG. 1;

FIG. 6 shows an enlarged partial side view of the container of FIG. 1, but with the wrist band being shown in cross-section;

FIG. 7 shows an enlarged partial side view of a modified version of the container of FIG. 1. In this embodiment, the groove or recess has an axial width that is substantially equal to or greater than an axial width of the wrist band so as to substantially receive therein the wrist band and allowing the wrist band to assume a shape which corresponds to a shape of the groove or recess. The wrist band is shown in cross-section;

FIG. 8 shows an enlarged partial side cross-section view of an upper portion of the container of FIG. 1, which illustrates the dual-wall configuration of the container body;

FIG. 9 shows an outer wall portion of the container of FIG. 8;

FIG. 10 shows a side cross-section view of an inner wall portion of the container of FIG. 1;

FIG. 11 shows a side view of an upper portion of the inner wall portion shown in FIG. 10;

FIG. 12 shows an enlarged partial side view of a modified version of the container of FIG. 1. In this embodiment, the groove or recess has a different tapered orientation. The wrist band is shown in cross-section;

FIG. 13 shows an enlarged partial side view of another modified version of the container of FIG. 1. In this embodiment, the groove or recess is generally cylindrically shaped and is sized to receive therein all or nearly all of the wrist band. The wrist band is shown in cross-section;

FIG. 14 shows an enlarged partial side view of an upper portion of a modified version of the container of FIG. 1, which illustrates the dual-wall configuration of the container body and which utilizes an outer wall portion that is substantially transparent or translucent. An optional handle is shown in dashed-lines;

FIG. 15 shows a side perspective view of one non-limiting embodiment a travel mug according to the invention; and

FIG. 16 shows a side perspective view of one non-limiting embodiment a sports bottle according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

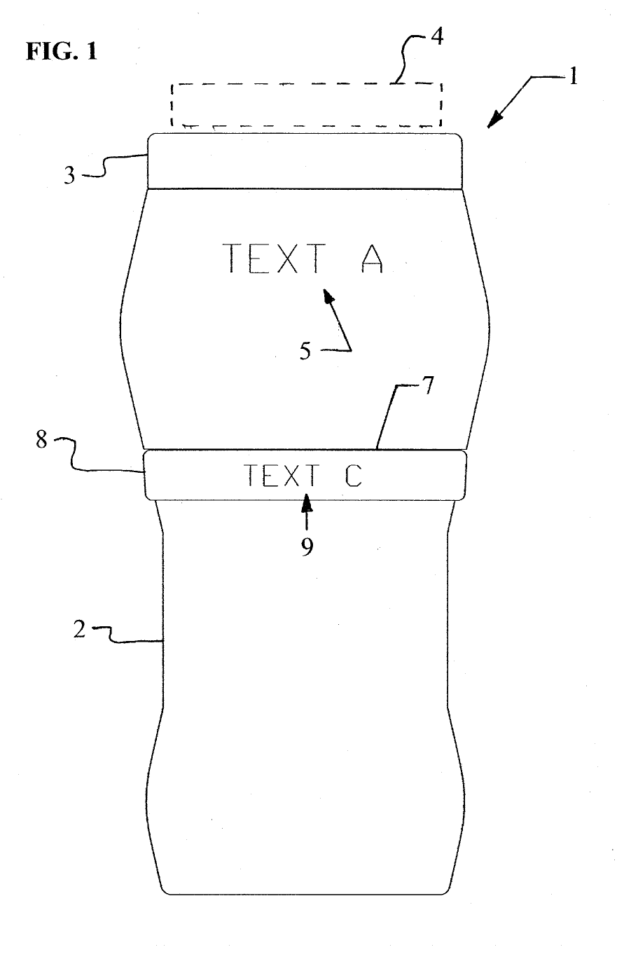

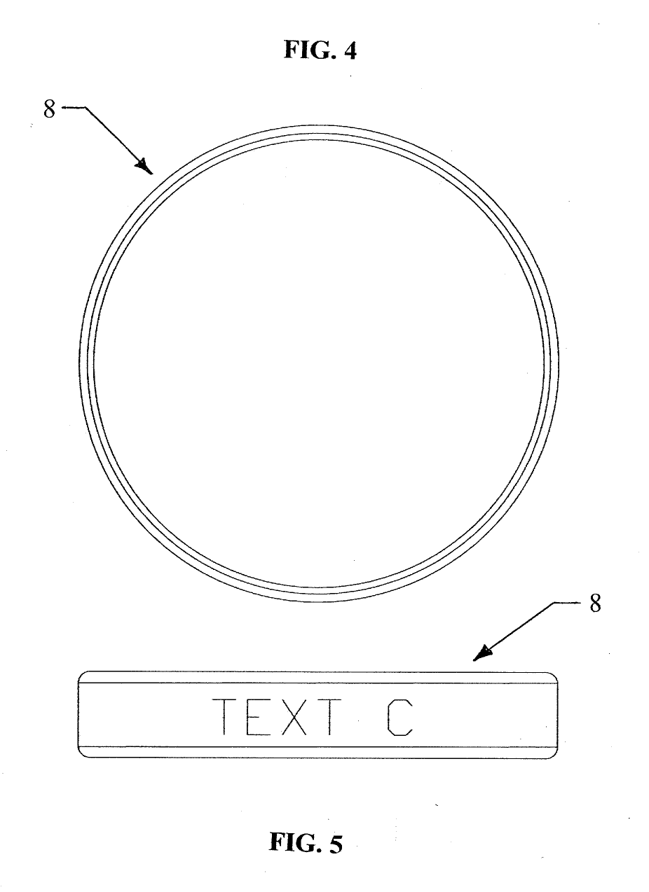

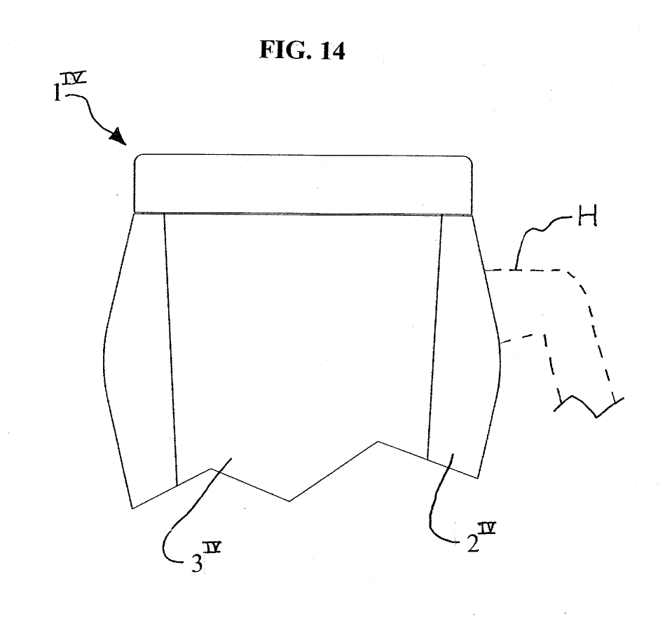

FIGS. 1-6 and 8-11 show a first non-limiting embodiment of a container 1. The container can be of any type that can contain a substance, e.g., a liquid, which can be consumed by a user, e.g., for drinking. In embodiments, the container can be a single wall container, a cup, a mug, etc. By way of non-limiting example, the container 1 is a dual-wall container includes an outer wall 2, an inner wall 3 and an optional cap 4. In embodiments, the container 1 is generally sized and shaped to contain a substance (not shown) such as a liquid or solid. By way of non-limiting example, the container 1 is sized to contain a volume of the substance that is between approximately ½ pint and a quart and is preferably a portable container. Although the container 1 is shown to have an ergonomic shape, it can also have any other desired size and shape and can preferably be of a size and shape of, e.g., conventional mugs, tumblers, etc. By way of non-limiting example, the container 1 can have an overall height (measured to the rim and with the cap 4 removed) of about 8 inches and a maximum diameter of about 3 inches. Although not shown in FIGS. 1-6 and 8-11, the container may utilize one or more handles similar to that shown in FIG. 14.

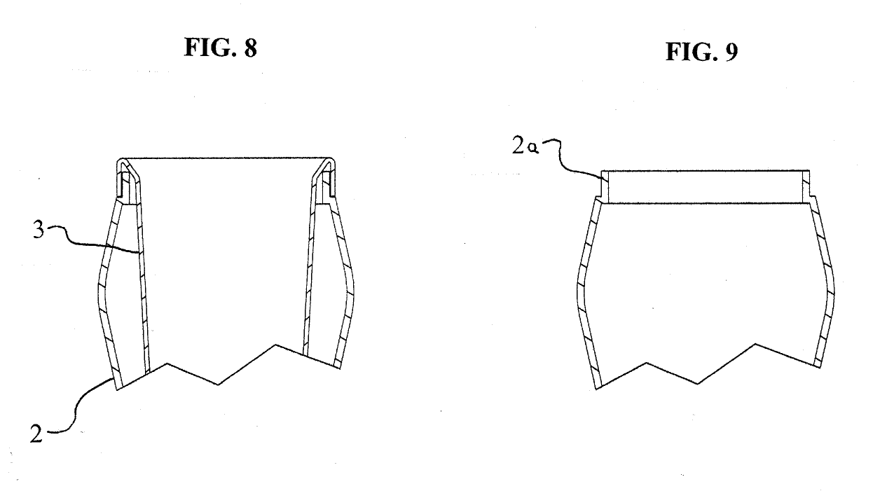

As is apparent from FIGS. 8-11, the inner wall 3 forms the container for the substance and includes a closed bottom, an open top and a generally tapered side wall. Of course, the inner wall 3 can any desired shape. By way of non-limiting example, the inner wall 3 can be made of a synthetic resin material such as e.g., PVC. In embodiments, the inner wall 3 is made of a metal which can be easily cleaned and/or sterilized and which is a good conductor of heat. By way of non-limiting example, the inner wall 3 can be made of e.g., 18-8 stainless steel. By way of non-limiting example, the inner wall 3 can also be a one-piece member that is made by deforming stainless steel sheet metal in a die. The thickness of the wall 3 can be any desired value. In embodiments, the inner wall 3 and/or any portion thereof is a solid color, non-transparent, transparent, or translucent. Also by way of non-limiting example, the upper portion 3a of the inner wall 3 can be bent over to form a rim.

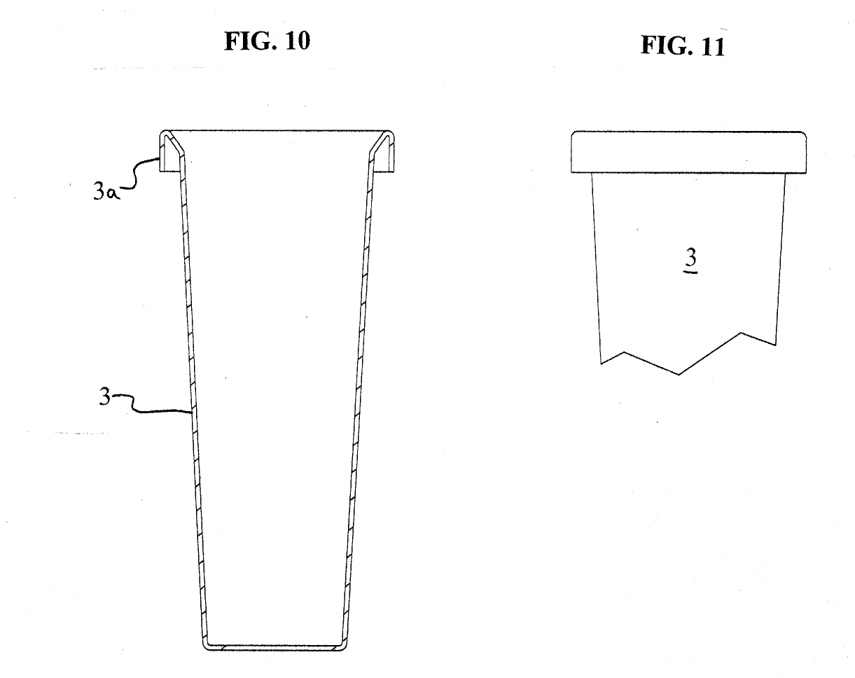

The outer wall 2 forms the outside shape of the container 1 and provides an insulation space (illustrated in FIG. 8) so as to prevent or limit heat transfer between the inner wall 3 and the outer wall 2. In this regard, the outer wall 2 is preferably generally larger than the inner wall 3. The outer wall 2 also includes a closed bottom, an open top and a generally tapered and/or shaped side wall. Of course, the outer wall 2 can be of any desired shape. By way of non-limiting example, the outer wall 2 can be made of a synthetic resin material such as e.g., PVC. In embodiments, the outer wall 2 can be generally colorless, substantially transparent or substantially translucent in order to make visible the inner wall 3 as illustrated in the embodiment of FIG. 14. The thickness of the wall 2 can be any desired value. Also by way of non-limiting example, the upper portion 2a of the outer wall 2 (see FIG. 9) can be configured with a shoulder in order to accommodate the bent over portion 3a of the inner wall 3. The upper portion 2a of the outer wall 2 can also be sealed to and/or secured (e.g., via an adhesive) to the bent over portion 3a of the inner wall 3 in order to ensure that the substance does not leak into the space between the outer wall 2 and the inner wall 3.

With reference to FIGS. 1-6, the outer wall 2 has an outer surface upon which text, indicia or one or more symbols 5 (identified as Text A) can be arranged. In embodiments, the indicia 5 can be a company name, logo, slogan, and/or trademark. In embodiments, the indicia 5 may be located in at least one location and may be repeated around the container plural times, e.g., in two opposite circumferential positions, in three opposite circumferential positions, or in four opposite circumferential positions, etc. A generally circumferential groove 7 is also arranged on the outer wall 2. The groove 7 is sized and configured to at least partially receive therein a removable wrist band or bracelet 8. The groove 7 has an outer surface upon which text, indicia or one or more symbols 6 (identified as Text B) can be arranged. In embodiments, the indicia 6 can be a phrase, slogan and/or trademark. In embodiments, the indicia 6 can be a single instance or may be repeated circumferentially around the groove 7 plural times, e.g., in two opposite or equally spaced circumferential positions, in three equally spaced circumferential positions, or in four equally spaced circumferential positions, etc. In embodiments, the indicia identified as Text B can be different from that identified as Text A. In embodiments, Text A and Text B can be the same. The wrist band 8 is sized and configured to be worn on a typical user's wrist and also placeable onto and removable from the container in the area of the groove 7. The band 8 has an outer surface upon which text, indicia, or one or more symbols 9 (identified as Text C) can be arranged. In embodiments, the indicia 9 can be a phrase, slogan or trademark. In embodiments, the indicia 9 can be a single instance or may be repeated around the band 8 plural times, e.g., in two opposite or equally spaced circumferential positions, in three equally spaced circumferential positions, or in four equally spaced circumferential positions, etc. In embodiments, the indicia 9 is different from that identified as Text A and Text B. In embodiments, the indicia 9 is the same as Text A and/or Text B. By way of non-limiting example, the indicia 5 is a company name, logo, trademark, slogan and/or symbol. The indicia 6 can be e.g., a phrase such as “Cup For A Cause”, and the indicia 9 can be, e.g., a word or phrase representing a cause. By way of non-limiting example, the indicia 5 can be printed or affixed onto the outer surface of wall 2, the indicia 6 and 9 can be respectively screen printed decals, embossed and/or indented, i.e., not in relief, into the groove 7 and wrist band 8.

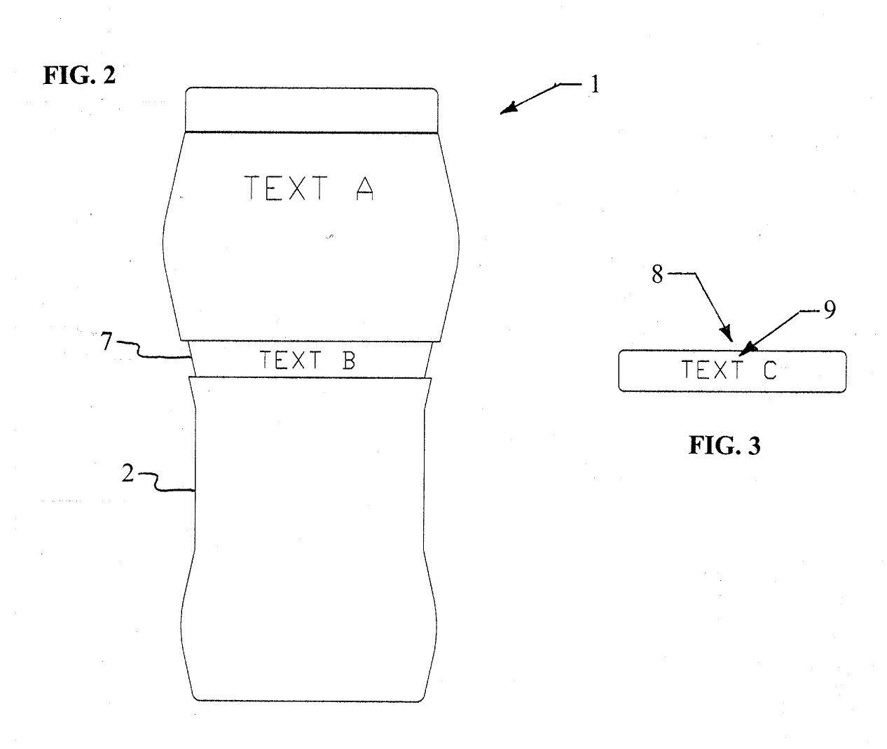

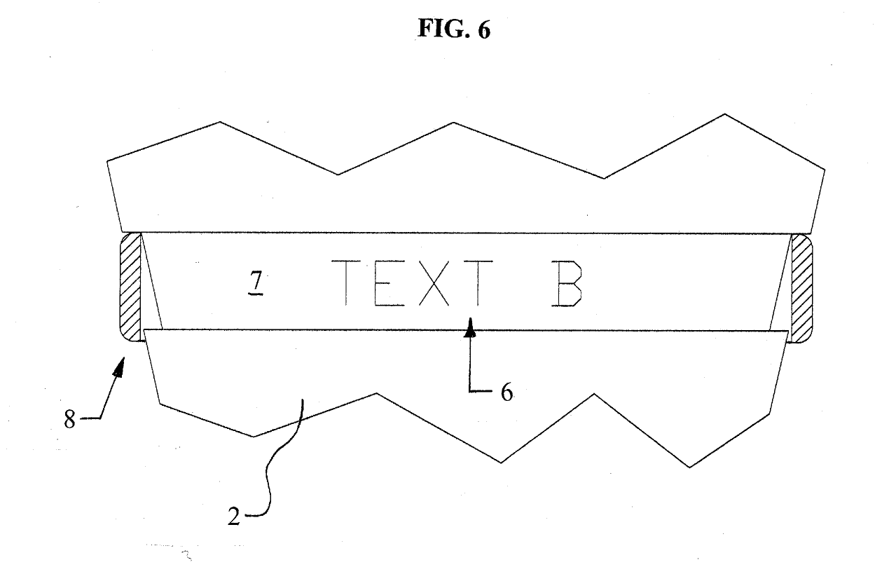

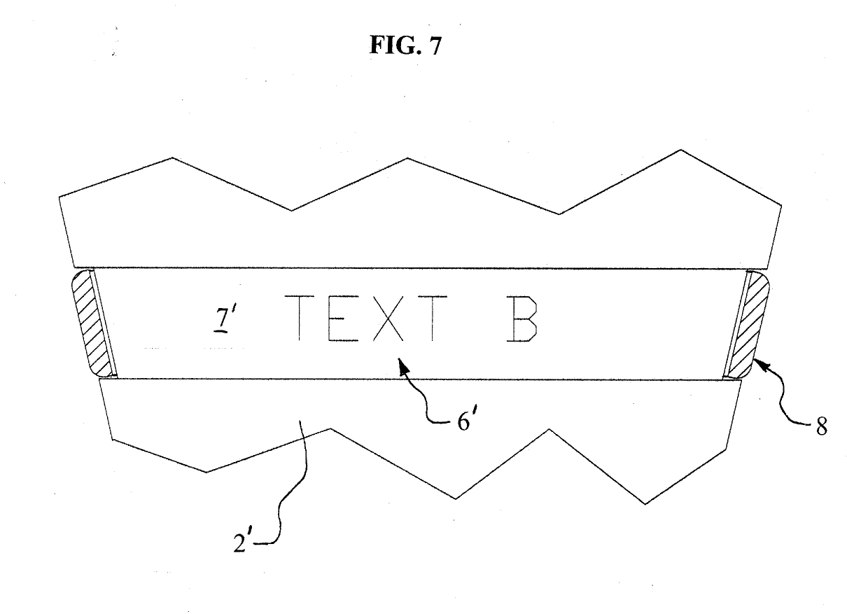

FIGS. 1 and 2 show the container 1 with the wrist band 8 installed and removed therefrom. In FIG. 1, the wrist band 8 has been installed in an area of the groove 7 (See also FIG. 6). In FIG. 2, the wrist band 8 has been removed from the area of the groove 7. As can be seen in FIG. 2, when the wrist band 8 is removed from the area of the groove 7, the indicia 6 (identified as Text B) is visible, which is not the case in FIG. 1. In embodiments, the wrist band 8 is a one-piece member, is flexible and elastically expandable, and is capable of expanding by an amount that allows a user to install and remove the same onto his or her wrist and also to install and remove the same onto the container 1. As is apparent from FIGS. 3-5, when the wrist band 8 is in an original relaxed state, it can have a generally cylindrical shape whose diameter is between about 60% and about 90% of a diameter of the groove 7. In embodiments, the band 8 is a cause or awareness bracelet or band of the type conventionally known, has an axial width (measured vertically in FIG. 5) of between about ¼ inch and about ½ inch, is substantially or nearly fully disposed (see e.g., FIG. 6) and/or fully disposed (see FIG. 7) within the at least one groove or recess 7.

FIG. 7 shows that the groove 7′ can be sized and configured to fully receive therein (in terms at least of an axial width thereof) of the wrist band 8. In this embodiment, the groove 7′ has an axial width which is slightly equal to or larger than an axial width of the wrist band 8. As with the previous embodiment, the groove 7′ similarly utilizes indicia 6′. Moreover, it is understood that the base of the groove 7′ on which Text B is arranged can be vertically oriented with respect to a longitudinal axis of the container so as to form a cylindrical surface.

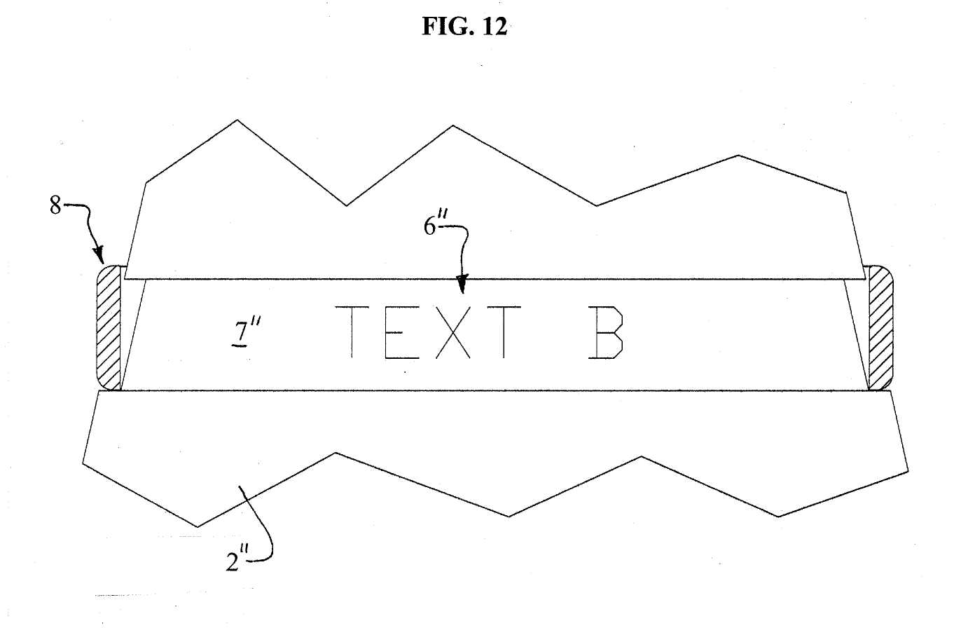

FIG. 12 shows that the groove 7″ can also be positioned on another area of the wall 2″ of the container. In this embodiment, the groove 7″ is arranged in a portion of the container which is tapered in a manner opposite that shown in FIGS. 1 and 6. However, it is apparent that the same wrist band 8 can be utilized owing to its elastic expandability. As with the previous embodiment, the groove 7″ similarly utilizes indicia 6″.

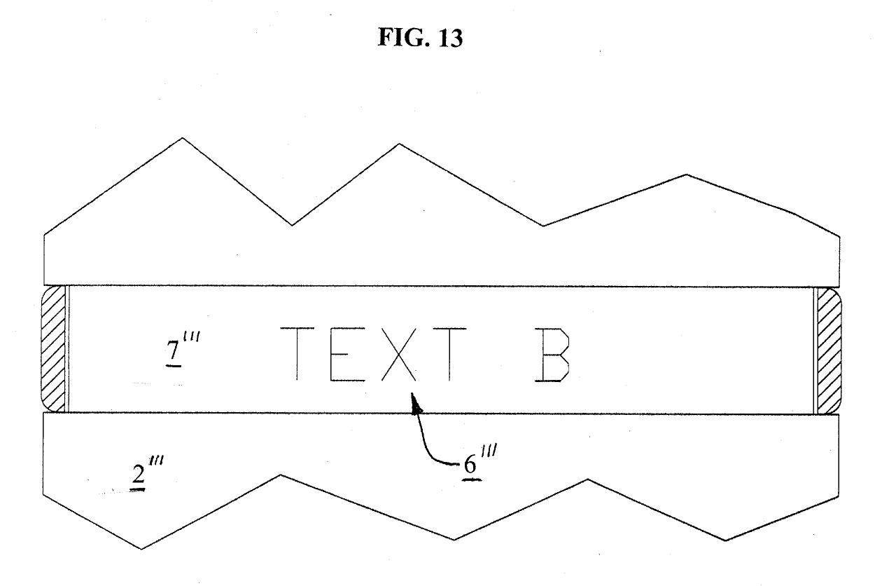

FIG. 13 shows that the groove 7′″ can also be positioned on another area of the wall 2′″ of the container. In this embodiment, the groove 7′″ is arranged in a portion of the container which is generally cylindrical and unlike the tapered areas shown in FIGS. 6 and 12. Again, it is apparent that the same wrist band 8 can be utilized owing to its elastic expandability. As with the previous embodiments, the groove 7′″ similarly utilizes indicia 6′″.

FIG. 14 shows an enlarged partial side view of an upper portion of a modified version of the container of FIG. 1. In this embodiment, the container utilizes an outer wall portion 2^{IV} that is substantially transparent or translucent. This allows the user to see the inner wall 3^{IV}. An optional handle H is shown in dashed-lines. Any one or more of the groove configurations 7, 7′, 7″, 7′″, shown and/or described above (as well as the indicia 5, 6 and 9 thereof) above can be utilized in order that this embodiment utilize a removable wrist band 8.

The indicia 5, 6 and 9 can of course be of any desired type and color and can be, e.g., a depiction of an object, one or more geometric shapes, one or more trademarks, one or more numbers, one or more letters, etc. According to one non-limiting embodiment, one or more of these indicia can be printed directly on a surface using, e.g., conventional inks. Alternatively, one or more of these indicia can be printed on a clear film, e.g., made of clear PVC. The film can then be position on a surface. According to still another embodiment, at least indicia 6 and 9 is integrally formed when the respective surface is formed, i.e., the indicia can be created when the surface is molded. According to still another embodiment, at least the indicia 5 and 6 can be in the form of self-adhesive imprinted labels or decals.

One non-limiting way of making the dual-wall container 1 includes forming the outer wall 2. Separately fanning the inner wall 3. The inner wall 3 is then placed into the outer wall 2 and secured thereto. Finally, the wrist band 8 is installed therein as shown in FIG. 1.

The invention also provides for a method of using the dual-wall container 1 of the type described above. The method includes removing the wrist band 8 from the container 1 and installed it on a user's wrist.

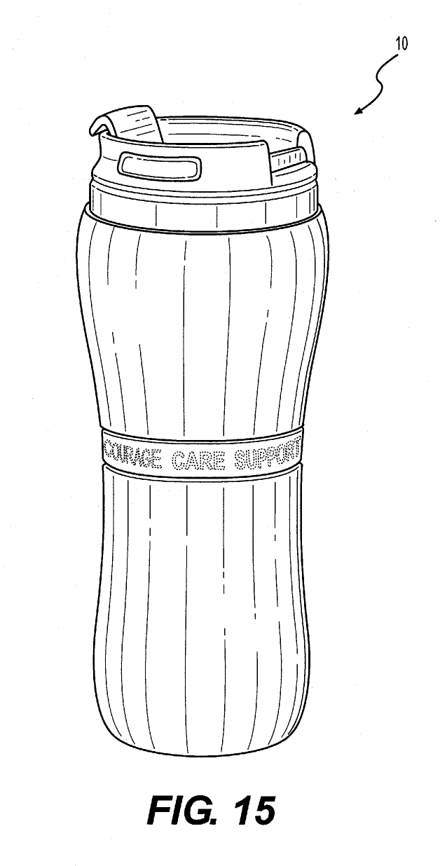

FIG. 15 shows a commercial embodiment of a dual-wall travel mug 10 utilizing a removable cap as well as a removable elastic wrist band according to the invention.

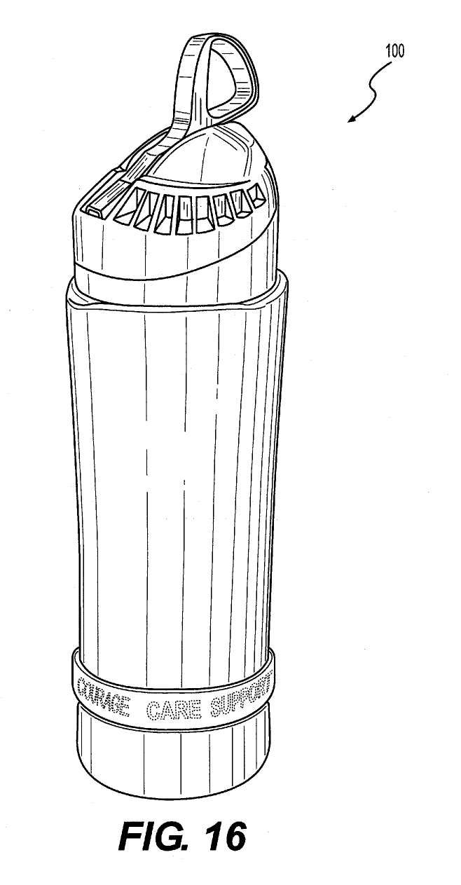

FIG. 16 shows a commercial embodiment of a dual-wall sports bottle 100 utilizing a removable cap as well as a removable elastic wrist band according to the invention.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A container comprising:
a container body;
at least one groove or recess arranged on the container body; and
a removable wrist band at least partially disposed in the at least one groove or recess,
wherein the wrist band is removable from the at least one groove or recess and wearable on a user's wrist.

2. The container of claim 1, wherein the wrist band is at least one of:
an elastic wrist band;
a one-piece member;
a cause or awareness bracelet or band;
an axial width of between about ¼ inch and about ½ inch;
substantially disposed within the at least one groove or recess; and
nearly fully disposed within the at least one groove or recess.

3. The container of claim 1, wherein the wrist band is elastically expandable and at least one of:
generally circular; and
generally cylindrically shaped.

4. The container of claim 1, wherein the wrist band comprises text and/or indicia and/or one or more symbols.

5. The container of claim 1, wherein the container body comprises text and/or indicia and/or one or more symbols.

6. The container of claim 1, wherein the at least one groove or recess comprises text and/or indicia and/or one or more symbols.

7. The container of claim 1, wherein the wrist band comprises at least one of the following:
text and/or indicia and/or one or more symbols, and
wherein the container body comprises at least one of the following:
text and/or indicia and/or one or more symbols.

8. The container of claim 1, wherein the wrist band comprises at least one of the following:
text and/or indicia and/or one or more symbols, and
wherein the container body comprises at least two of the following:
text and/or indicia and/or one or more symbols.

9. The container of claim 1, wherein the container body comprises at least one of:
an inner wall and an outer wall; and
an inner wall and an outer wall and wherein the least one groove or recess is arranged in the outer wall.

10. The container of claim 1, wherein the least one groove or recess is at least one of:
arranged on a one-piece member; and
integrally formed with a wall of the container body.

11. The container of claim 1, wherein the container body comprises an outer wall having text and/or indicia and/or one or more symbols.

12. The container of claim 11, wherein the outer wall is at least one of:
at least partially substantially transparent;
at least partially substantially opaque. and
at least partially substantially translucent.

13. The container of claim 1, wherein the container body comprises one of:
an outer wall comprising a synthetic resin and an inner wall comprising a metal;
an outer wall comprising a synthetic resin and an inner wall comprising a synthetic resin;
an outer wall comprising a synthetic resin and an inner wall comprising stainless steel; and
an outer wall comprising PVC and an inner wall comprising 18-8 stainless steel.

14. The container of claim 1, further comprising at least one of
a cap arranged to cover an opening of the container; and
at least one handle for gripping the container.

15. The container of claim 1, wherein the wrist band is at least one of:
elastically expandable and comprises, in at least two spaced apart locations, text, indicia and/or at least one symbol; and
elastically expandable and comprises plural spaced apart locations a same text, indicia and/or at least one symbol.

16. The container of claim 1, wherein the at least one groove or recess comprises at least one of:
plural spaced apart locations text, indicia and/or at least one symbol;
plural spaced apart locations a same text, indicia and/or at least one symbol; and
plural spaced apart locations of a trademark.

17. A method of making the container of claim 1, the method comprising:
placing the removable wrist band in the at least one groove or recess.

18. A method of using the container of claim 1, the method comprising:
removing the removable wrist band from the at least one groove or recess.

19. A container comprising:
a container body;
at least one groove or recess arranged on the container body and having an axial width of between about ⅜ inch and about ½ inch;
a generally cylindrically shaped wrist band at least partially disposed in the at least one groove or recess; and
the wrist band being removable from the at least one groove or recess and wearable on a user's wrist,
wherein at least one of:
the wrist band comprises text and/or indicia and/or one or more symbols;
the container body comprises text and/or indicia and/or one or more symbols; and
the at least one groove or recess comprises text and/or indicia and/or one or more symbols.

20. A method of making a container comprising:
arranging a removable elastically expandable wrist band in at least one groove or recess located on an outer surface of a body of the container,
wherein the wrist band is wearable on a user's wrist.
